(19) United States
(12) Patent Application Publication
(10) Pub. No.: US 2003/0061528 A1
(43) Pub. Date: Mar. 27, 2003

(54) Method and system for controlling clock signals in a memory controller

(75) Inventors: Rodney Daniel Blake, Savage, MN (US); Allen Nicholas Kramer, Hudson, WI (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/183,297

(22) Filed: Jun. 26, 2002

Related U.S. Application Data
(60) Provisional application No. 60/325,338, filed on Sep. 27, 2001.

(51) Int. Cl. G06F 1/04

(52) U.S. Cl. 713/600

(57) ABSTRACT

A system and method of controlling the timing of a clock signal delivered to one or more memory modules, such as SDRAM modules, wherein the system clock speed is relatively fast. The system and method uses a buffer that is similar to other buffers in the system to delay the output of the clock signal in order to provide accurate tracking over differences attributable to process, voltage and temperature. In order to incorporate similar buffer components for the control lines and the clock signal, delay elements are inserted in the timing structure to accurately delay the output timing of the data and control lines as compared to the clock signal. These delay elements, therefore, provide the setup and hold characteristics with a significant amount of accuracy.

### RELATED APPLICATION

This application claims priority of U.S. provisional application Serial No. 60/325,338, titled SELF TIMED SDRAM INTERFACE, filed Sep. 27, 2001, which is incorporated herein by reference.

### FIELD OF THE INVENTION

The present invention relates to methods and systems for controlling clock signals delivered to memory devices. More particularly, the present invention relates to controllers for synchronous dynamic random access memory (SDRAM) modules and timing issues involved therewith.

### BACKGROUND OF THE INVENTION

Many computer and other microprocessor-based systems incorporate synchronous dynamic random access memory (SDRAM) modules for increased performance. Indeed, the popularity of SDRAM has increased such that now many different devices include SDRAM modules, such as laptop computers, printers, disc drive systems and tape drive systems, among others. In general, SDRAM modules are DRAM modules that are synchronized to a system clock that controls the microprocessor for the system. Synchronizing the SDRAM modules in this manner provides many benefits. For instance, it is well known that since the clock that controls the microprocessor also controls the SDRAM, wait states may be reduced or eliminated thereby improving data retrieval times.

SDRAM modules typically operate in conjunction with a controller, wherein the controller provides many functions, including supplying the clock signal to the SDRAM modules that ultimately controls the timing of the SDRAM modules. Further, the controller typically controls the conduction of other signals, such as address and data signals to the SDRAM modules. In order to control the conduction of address and data signals, the controller uses a series of latches and buffers for latching actual data and address information into the controller and then launching this information onto data and address lines connected to the SDRAM modules. Since the controller controls timing of the signals on the data and address lines, the controller is able to also supply clock signals to the SDRAM modules in accordance with the timing of the data and address signals to ensure proper operation of the SDRAM modules.

Importantly, each SDRAM module has specific timing constraints by which the controller must operate. For instance, typical SDRAM modules typically have setup and hold timing requirements relating to the time periods in which the information on the control lines, i.e., the data and address information or “SDRAM control signals”, must be stable before the memory controller transmits the next rising edge of the control clock signal and how long the information should remain stable following that next rising edge of the clock signal, respectively. As an example, some SDRAM modules require two to three nanoseconds of setup time prior to receiving a rising edge clock signal and one to two nanoseconds of hold time immediately following the rising edge of the clock signal. These requirements provide the SDRAM the ability to trust the SDRAM control signals on the control lines at the time the rising edge of the clock signal appears and the ability to adequately latch the information into the SDRAM modules following the appearance of the rising edge.

In the past, the setup and hold timing requirements were not particularly burdensome on the memory controller since the SDRAM modules operated at high speeds in comparison to the rate of the system clock used to control the timing of the SDRAM modules. Consequently, prior methods of controlling the timing of the SDRAM modules related to simply monitoring when the SDRAM control information, i.e., the address and data signals, was launched onto the control lines and then sent a timing control signal to a short delay buffer, which, in turn, produced a clock control signal for the SDRAM module. In order to achieve this function, upon latching a control value, one of the many latches would simply conduct another signal to the delay buffer. The delay buffer, also referred to as a delayed switch, was designed to transmit a rising-edge clock signal following a setup time period that satisfied the timing requirements for the SDRAM modules. Since the system clock was relatively slower than the timing requirements needed for the SDRAM modules, the hold requirements were generally met by simply waiting for the next system clock signal to latch more control values into the controller.

As microprocessor technology improves, however, system clock rates are significantly increasing. Unfortunately, as the system clock speed increases, the time between rising edges of the clock signal decreases which introduces new problems associated with the SDRAM clock signals vis a vis setup and hold requirements for the SDRAM modules. As the window of time between rising edges of the clock signal decreases, more and more emphasis is placed on the precise timing characteristics of the delayed switch. Indeed, as the system clock rates have increased, the delayed switch has become a very fast, tightly controlled element within the controller. Higher performance switches are being used to improve the timing window to accommodate the higher system clock rates.

Although high performance switches satisfy some issues of controlling the timing for faster system clock speeds, a drawback exists. In particular, given that the memory controllers operate in many different environments, having many different combinations of process, voltage and temperature (PVT), the operating characteristics of the different elements within the controllers become difficult to predict in relation to other elements for these many different environments. As such, the high performance switches do not provide the tight control necessary to satisfy the requirements of the SDRAM modules for some of these environments. For example, in a particular environment operating at a high temperature, the speed in which the latches within the controller latch information onto a control line may decrease substantially while the timing of the high performance switch may not change in the high-temperature environment. In such a case, the high performance switch may not delay an adequate amount of time before transmitting the next rising edge of the clock signal to the SDRAM module and consequently violate the setup-time requirement.

It is with respect to these and other considerations that the present invention has been made.

### SUMMARY OF THE INVENTION

The present invention relates to controlling the timing of a clock signal delivered to one or more memory modules, such as SDRAM modules, wherein the system clock speed is relatively fast. Input/Output (I/O) elements or buffers are used to delay the output of the clock signal. Similar I/O elements are used in order to provide accurate tracking over differences attributable to process, voltage and temperature (PVT). In order to incorporate similar I/O buffer components for the control lines and the clock signal, delay elements are inserted in the timing structure to accurately delay the output timing of the data and control lines as compared to the clock signal. These delay elements, therefore, provide the setup and hold characteristics required by the memory modules with a significant amount of accuracy.

In accordance with certain aspects, the present invention relates to a memory controller for controlling the timing of a memory clock signal wherein the memory clock signal is conducted to one or more synchronous dynamic random access memory modules and wherein the memory modules are part of a system having a host computer system that operates in accordance with a system clock signal. In this embodiment, the controller has a phase lock loop module that receives the system clock signal from the host computer system and produces an internal clock signal. The controller also has a plurality of latches that receive information from the host computer system, which is used to control the memory modules. The latches also receive the internal clock signal from the phase lock loop module. The controller also has a plurality of buffers, wherein each buffer is associated with one of the plurality of latches and wherein each latch sends a latch signal to the associated buffer and in response, each buffer sends an information signal to at least one memory module. Moreover, the controller has a clock buffer that receives a clock signal from the phase lock loop module and conducts a clock signal to one or more memory modules. The clock buffer is substantially similar to the buffers associated with the latches in order to accurately track across process, voltage and temperature variations.

In accordance with other aspects, the present invention relates to a controller that further uses a plurality of delay elements, wherein the delay elements delay the timing of the latches. The delay elements may be used to delay the timing of at least one latch to operate at a different time from at least one other latch, or stagger the operation of the various latches to reduce the effects of SSO, i.e., simultaneously switching outputs.

A more complete appreciation of the present invention and its improvements can be obtained by reference to the accompanying drawings, which are briefly summarized below, to the following detailed description and presently preferred embodiments of the invention, and to the appended claims.

### BRIEF DESCRIPTION OF THE DRAWINGS

FIG. 1 illustrates a disc drive storage media device that incorporates one or more memory modules, such as SDRAM modules, and a control module according to aspects of an embodiment of the present invention.

FIG. 2 illustrates a system configuration including electronic elements of the disc drive shown in FIG. 1, such as the SDRAM modules and the control module referred to in FIG. 1.

FIG. 3 illustrates an SDRAM control module that derives an SDRAM clock signal using a clock buffer that is different from the control line buffers.

FIG. 4 illustrates an SDRAM control module according to the present invention wherein the SDRAM clock signal is derived using a buffer that is substantially similar to the control line buffers.

FIG. 5 illustrates an exemplary timing diagram of sample signal waveforms for the system shown in FIG. 4.

FIG. 6 illustrates another exemplary timing diagram of sample signal waveforms associated with the control module shown in FIG. 4 with control signals divided into two.

FIG. 7 illustrates a flow chart of functional operations related to transmitting a clock signal according to an embodiment of the present invention.

### DETAILED DESCRIPTION

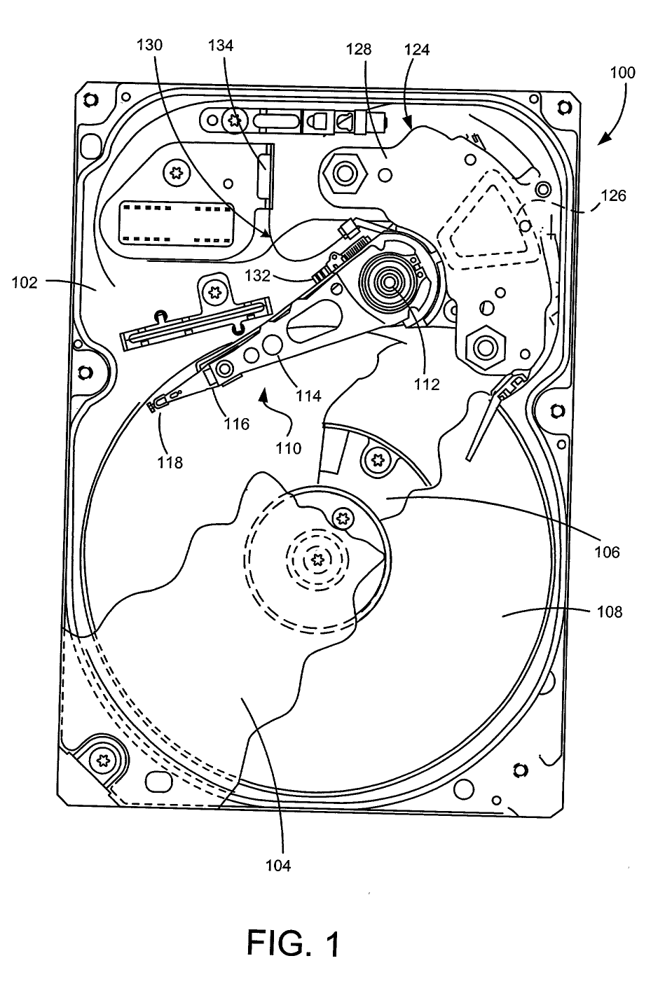

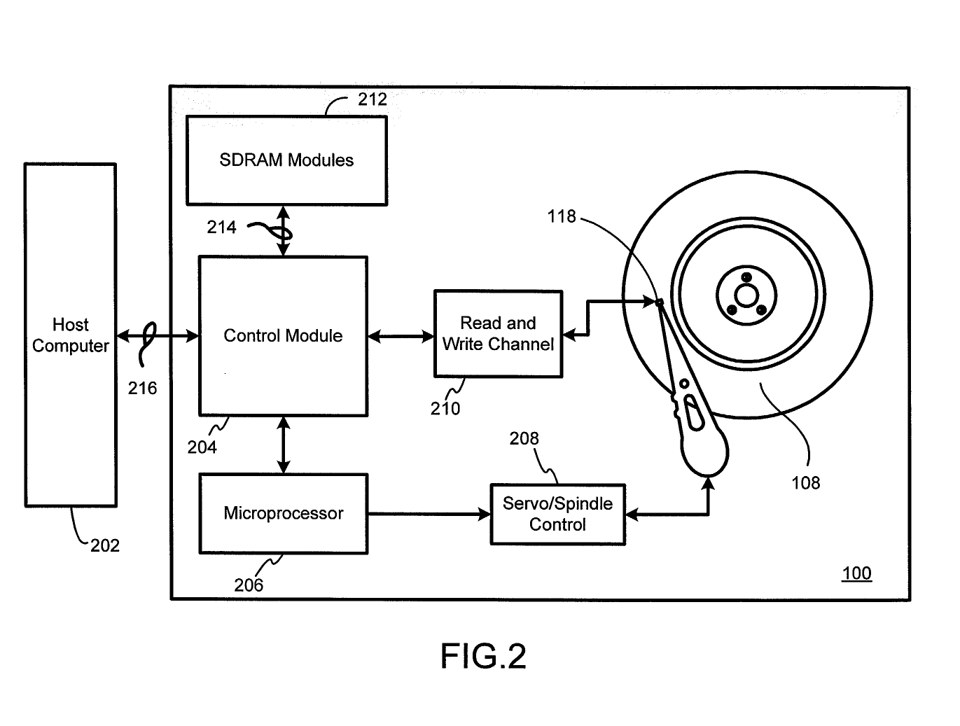

In general, the present disclosure describes controlling the timing of a clock signal and control signals to be conducted to an SDRAM module in a system with a relatively high-speed system clock. A disc drive device 100 that may incorporate aspects of the present invention is shown in FIG. 1. It should be understood that other environments which use SDRAM modules, such as other computing environments, are contemplated and may be within the scope of the present invention. Similarly, it should be understood that other environments that use other types of memory modules, i.e., non-SDRAM modules may also fall within the scope of the present invention. Hence, FIGS. 1 and 2 and related descriptions are intended to provide a background environment in which the present invention may be practiced.

In an embodiment, the disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to move or fly in close proximity above the corresponding surface of the associated disc 108.

During operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones (not shown) near the inner diameter of the discs 108 when the drive motor is de-energized. The heads 118 are secured over the park zones through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base 102 to a disc drive printed circuit board (not shown) mounted to the bottom side of the disc drive 100. The disc drive printed circuit board is used to connect the disc drive 100 to a host computer system and control many of the functional operations of the disc drive 100.

Referring now to FIG. 2, shown therein is a functional block diagram of the disc drive 100 of FIG. 1, generally showing the main functional circuits which are typically resident on a disc drive printed circuit board and which are used to control the operation of the disc drive 100. As shown in FIG. 2, a host computer 202 is operably connected to an interface application specific integrated circuit or control module 204 via both control lines and data lines 216. A microprocessor 206 is operably connected to the module 204 and provides top-level communication and control for the disc drive 100. Programming for the microprocessor 206 is typically stored in a microprocessor memory (not shown). Additionally, the microprocessor 206 provides control signals for servo and spindle control 208.

Data to be written to the disc drive 100 is passed from the host 202 to the control module 204 and then to a read/write channel 210, which encodes and serializes the data. The read/write channel 210 also provides the requisite write current signals to the heads 118. To retrieve data that has been previously stored by the disc drive 100, read signals are generated by the heads 118 and provided to the read/write channel 210, which processes and outputs the retrieved data to the interface control module 204 for subsequent transfer to the host 202. Such previously described operations of the disc drive 100 are well known in the art and are discussed, for example, in U.S. Pat. No. 5,276,662 issued Jan. 4, 1994 to Shaver et al.

In accordance with the present invention, the system 100 also includes one or more memory modules or buffer 212. In one embodiment the memory modules 212 are synchronized dynamic random access memory (SDRAM) modules. The control module 204 manages the memory 212 in response to commands received from the host 202, as discussed below. The memory buffer 212 facilitates high speed data transfer between the host 202 and the disc drive 100 and may be used to temporarily store data that is to be transferred either to the disc media 108 or to the host 202.

The control module 204, also referred to as the “controller,” operates in conjunction with a system clock (not shown). The system clock has a predetermined frequency, i.e., the time between rising edges of the clock signal. The control module 204, therefore, receives a clock signal and uses it to control the timing of its operations, including the launching of data and control signals onto connection lines 214 to and from the SDRAM modules 212 in relation to the system clock frequency.

Each SDRAM module 212 has predetermined timing requirements related to setup and hold times by which the data on various address and data control lines 214 must be stable. The setup and hold times are determined from the rising edge of the clock signal conducted to the SDRAM module by the controller 202. Thus, the controller 214 must adhere to these requirements, regardless of the speed of the system clock, in order to satisfy the requirements of the SDRAM modules. The controller 204 provides memory clock signals so as to satisfy these requirements for a relatively fast system clock.

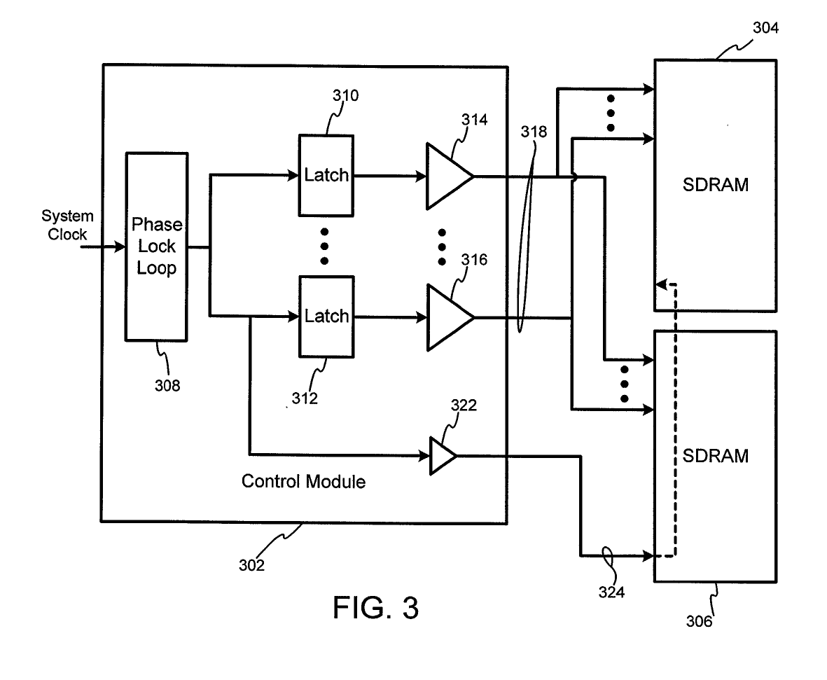

FIG. 3 illustrates a block diagram of a controller 302, and some of its components used in controlling the timing of clock and data signals conducted to SDRAM modules 304 and 306. In comparing FIG. 3 to FIG. 2, the controller 204 (FIG. 2) is essentially the controller 302 (FIG. 3) and the SDRAM modules 212 (FIG. 2) correspond to SDRAM modules 304 and 306 (FIG. 3). The controller 302 has a phase lock loop module 308 that receives the system clock signal and is used to generate a new clock signal, i.e., an internal signal to be used to control internal components, wherein the new clock signal is related to the original system clock signal. The phase lock loop module 308 conducts a clock signal to data and control latches 310 and 312. The latches 310 and 312 exemplify the latches used by the controller in receiving data and address values from another module, such as microprocessor 206 or a host 202 (FIG. 2). Typically, the controller 302 provides many address and data control signals. For example, in one embodiment fifty-three different control signals are managed by controller 302 such that there may be over fifty different latches such as 310 and 312 in the controller 302. The phase lock loop 308 therefore provides the latch control signals that latch these different control values into the controller 302. Once latched, the output of each latch such as 310 and 312 is launched, such as through output elements, e.g., I/O buffers 314 and 316 as an SDRAM control signal, onto one of the control lines 318, which are connected to the SDRAM modules 304 and 306. The controller 302 also provides a clock buffer 322 that buffers a clock signal 324, which is conducted to the SDRAM modules as well.

In order to control the relative timing of the clock and data signals, the I/O buffers of the control lines 318 have timing characteristics that are significantly different from the I/O buffer 322 used to buffer the clock output. For example, the buffers, such as buffers 314 and 316, used for each of the many control lines may be similar, where each has a switching delay of approximately three to four nanoseconds. The I/O buffer used for the clock signal, in this example, may have a delay of approximately one to one and one-half nanoseconds. Thus, the signals on the control lines will not change until approximately one and one-half to three nanoseconds after the clock signal. The time between the clock signal and the change of the signals on the control lines relates to the hold time, and thus, the hold time is controlled by the I/O buffer characteristics.

Unfortunately however, each I/O buffer has an associated variance in the delay time. The variances are partially attributable to inconsistencies associated with the production process, the voltages used to drive a buffer or the temperature environment in which the buffers are operating. Thus, for the I/O buffers 314 and 316 used in launching data onto the control lines, a best case and a worst case situation can be determined wherein the delay may be, for example, two and one-half nanoseconds for the best case operation and five nanoseconds for the worst case situation. Similarly, the I/O buffer 322 for the clock signal, which is designed to be relatively fast, may have one nanosecond best case characteristic and a two nanosecond worst case characteristic. Using these values, the hold times may vary between to three nanoseconds and one and one-half nanoseconds depending on process, voltage and temperature, i.e., PVT. Consequently, variances in the timing differences between control input/output (I/O) buffers 314 and 316 and the clock buffer 322 may be relatively large such that some combinations do not provide enough setup or hold time for the SDRAM modules to accurately receive the proper data as the speed of the system clock, or the speed of the clock signal provided by the phase lock loop module 308 increases.

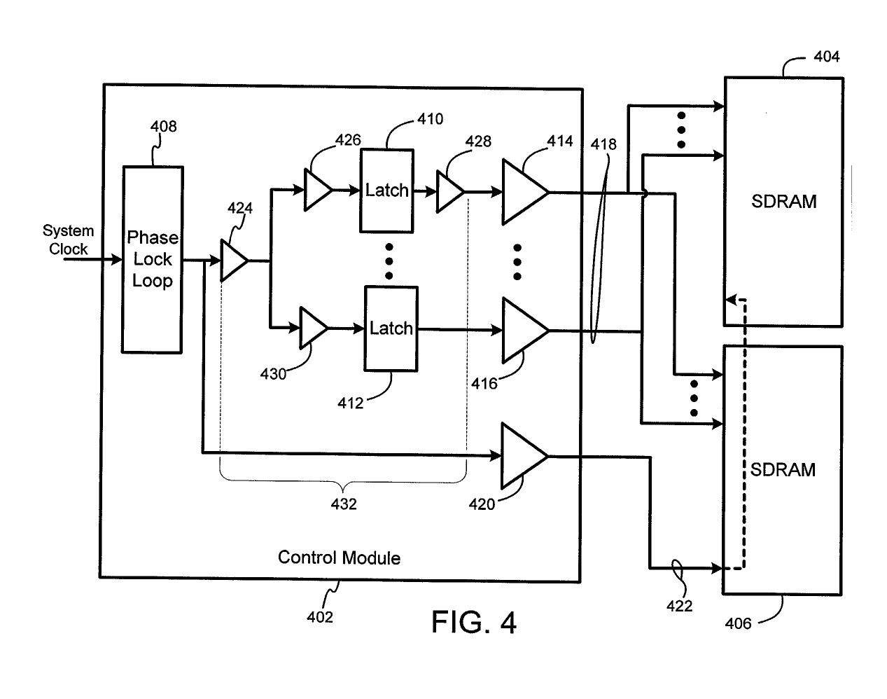

FIG. 4 illustrates an embodiment of the invention having a controller 402 that supplies control and clock signals to SDRAM modules 404 and 406 in a manner that compensates for the increased speed of the clock while compensating for PVT such that satisfactory setup and hold times are maintained. The controller 402 has a phase lock loop module 408 which is similar to module 308 (FIG. 3) that supplies clock signals to latches 410 and 412. The latches are, as discussed above in conjunction with FIG. 3, representative of the many latches that may be used to ultimately supply different data and address signals to the SDRAM modules 404 and 406. For instance, in one particular embodiment, there may be fifty-three or more data and control signals supplied to the modules 404 and 406 such that there may be fifty-three or so latches. Additionally, output elements 414 and 416 buffer the output signals provided by latches 410 and 412 as the data is set or launched on the control lines 418. In an embodiment, the output elements may be I/O buffers used to raise the voltage level of the signal to a predetermined level in order for the SDRAM modules to differentiate between various signals. Additionally, each output element 414 and 416 introduces a delay between the time in which a signal is received and the time the signal is launched onto one of the control lines 418.

The embodiment shown in FIG. 4 also has an output element 420 that buffers a clock signal received from the phase lock loop module 408 and conducts a clock signal 422 to the SDRAM modules 404 and 406. The output element or buffer 420 is substantially similar to the output elements or buffers 414 and 416 and in one particular embodiment, the buffer 420 is the same component as the buffers 414 and 416. Consequently, one of primary differences between the clock buffer 322 shown in FIG. 3 and the clock buffer 420 shown in FIG. 4, is that the buffer 420 used to buffer the output clock signal is the same or substantially similar component as is used to generate the other control signals. By making the buffers 414, 416 and 420 the same, the impact of variances due to process, voltage and temperature are minimized. Thus, the timing variances between the buffer 420 and the buffers 414 and 416 are minimized as well.

In order to create a hold delay between the clock signal 422 and the control signals launched on lines 418, the control module 402 further includes delay elements 424, 426, 428 and 430. Delay elements 424, 426, 428 and 430 are controlled delay elements with predetermined timing delay characteristics. The delay elements 424, 426 and 430 may be referred to as part of a clock “fanout” structure that duplicates latch control signals provided to latches 410 and 412. Moreover, the delay elements 424, 426 and 430 essentially delay the output control signals a predetermined time following the rising edge of the clock signal 422. These delay elements may be part of the normal clock fanout structure or may be added if the delay of the clock fanout structure is not sufficient under best-case PVT conditions to produce enough delay to meet the minimum hold time requirements of the SDRAM module. If the delay of the entire clock fanout structure exceeds the minimum hold time requirements of the SDRAM modules, then the clock signal 422 will be taken from a different point in the clock fanout structure, such as after delay element 424, such that the delay introduced by the clock fanout structure is substantially identical to the hold time requirements of the SDRAM modules. In an embodiment, the delay elements 424, 426 and 430, in the clock fanout structure introduce relatively small increments of time delay. Consequently, a timing delay between the clock signal 422 and control signals on lines 418 may be achieved wherein the delay is substantially identical to the hold time requirement of the SDRAM modules 404 and 406. Additionally, latches 410 and 412 have a predetermined delay characteristic as well, and therefore the latch characteristics are also calculated into the total delay past the rising edge of the clock signal. Thus, as shown in FIG. 4, the components 432 are used to establish the proper difference in time in which the clock signal 422 and the control signals on control lines 418 are conducted.

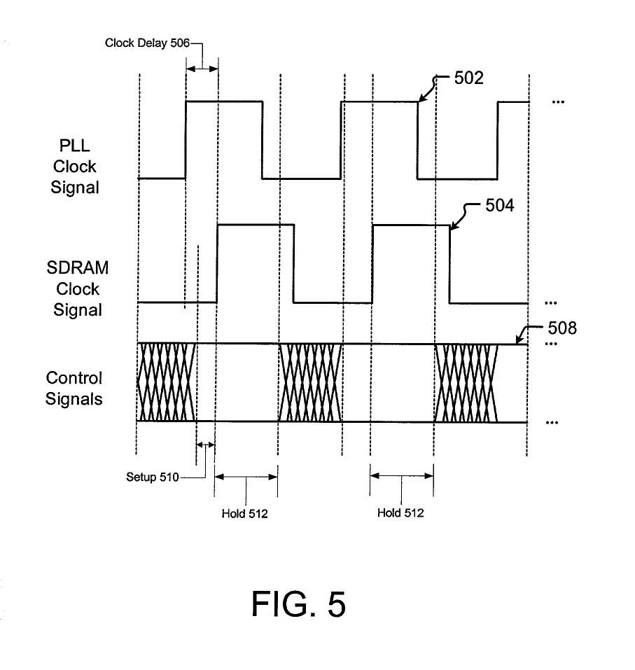

FIG. 5 illustrates sample signal waveforms relating to the control module 402 shown in FIG. 4. As shown, phase lock loop signal 502, i.e., PLL clock signal, is a repeating clock pulse. The PLL signal is based on the system clock signal (not shown) received from the host computer system 202 (FIG. 2). Also shown is SDRAM clock signal 504, which represents the clock signal 422 conducted to the SDRAM modules 404 and 406, described above in conjunction with FIG. 4. The SDRAM clock signal 504 is delayed from the PLL clock signal by a predetermined delay 506. The delay, in one embodiment, is created by an output element, such as buffer 420 that is similar to other output elements or buffers used in the system, such as buffers 414 and 416. As may be appreciated, the clock signal 504 may be faster than the system clock. That is, the SDRAM clock signal 504 may be set to switch two or three times faster than the system clock as long as it is related to the system clock.

FIG. 5 also illustrates the timing of control signals, i.e., first set of control signals 508, with respect to the timing of the SDRAM clock signal 504. In particular, the control signals 508 are available or launched on the transmission lines at the times illustrated by representation 508. As shown in FIG. 5, the control signals provide a setup time 510 that represents the time in which the data on the control lines are stable prior to the rising edge of the SDRAM clock signal 504. Also as shown in FIG. 5, the control signals 508 have a hold time 512, which represents the time that the data is stable on the transmission lines following the SDRAM clock signal 504. The hold time 512, in one embodiment, is determined in part by control elements 432 shown in FIG. 4. Similarly, the setup time 510 is therefore also controlled by the control elements 432 shown in FIG. 4, due to the nature of the synchronous system 402. Since the embodiment allows the actual hold time 512 to be substantially equivalent to the required hold time of the SDRAM modules, the amount of time the signal is delayed under worst-case PVT conditions is also minimized. The time difference between the rising edge of clock 422 and the signals 418 is the worst-case delay introduced by elements 432. Any other delays are minimized due to the use of substantially identical buffers 414, 416 and 420, which will have the same delay under all PVT conditions. The hold time minimization made possible by delay 432 generally maximizes the setup time at the SDRAM module.

The benefits of the system shown in FIG. 4 are numerous. In particular, the use of a buffer 420 to buffer the clock output signal that is the same or substantially similar component as buffers 414 and 416, which are used to buffer the control signals 418, provides consistent tracking over differences related to process voltage and temperature. That is, the impact of process voltage and temperature on the timing differences between when the data is stable on the transmission lines for a PVT and when the rising edge of the clock signal 504 occur is reduced. Reducing the impact of PVT significantly improves the timing control of the system 402. Indeed, the improvements with respect to PVT lead to yet other implementations and benefits.

One such benefit, relates to the reduction of the impact created or caused by simultaneously switching outputs (SSO). SSO relates to a phenomena of noise within the system that is created by many latches simultaneously switching. As is known in the art, as an 1/0 buffer switches, two transistors are essentially on at the same time creating a voltage to ground current path. When many 1/0 buffers simultaneously switch, a significant amount of current is drawn between the voltage and ground. The simultaneous occurrence, therefore, generates a small current spike at that particular time. The current or voltage spike may be propagated throughout the system and therefore impact other components. Indeed, the effect of SSO is increased as the number of output elements, or simply “outputs,” such as outputs 414 and 416, increases. The control module 402 provides a system to reduce the impact of SSO.

In order to reduce the impact of SSO, the control module 402 staggers the timing for the various outputs, such as outputs 414 and 416. As shown in FIG. 4, output 414 is delayed by delay elements 424, 426 and 428. These delay elements essentially define the time by which the output 414 will switch, e.g., the time which the output 414 will draw current. Also, as shown in FIG. 4, output 416 is delayed by delay elements 424 and 430. However, delay elements 424 and 430, which are used to delay the output 416, are fewer than those used to delay the output 414. In essence, output 416 will switch before output 414, since there is an additional delay element 428 in the path associated with output 414. Since output 416 will draw current before output 414, the outputs 414 and 416 will not draw current at the same time which reduces the impact of SSO. In alternative embodiments the outputs may draw a certain amount of current at the same time but theoretically the peak time involved in the drawing of current will not be simultaneous. Therefore, the impact of SSO is reduced.

Importantly, the ability to provide additional delay elements, i.e., staggering the output timing between 414 and 416 is enabled by the relatively tight control between buffered clock output 424 and buffered clock signal outputs 418. That is, since the timing at which the rising edge of the clock signal 504 is going to track tightly across process voltage and temperature with respect to the other control signals 508, additional delay elements may be introduced into the system 402 without jeopardizing setup and hold requirements of the SDRAM modules 404 and 406.

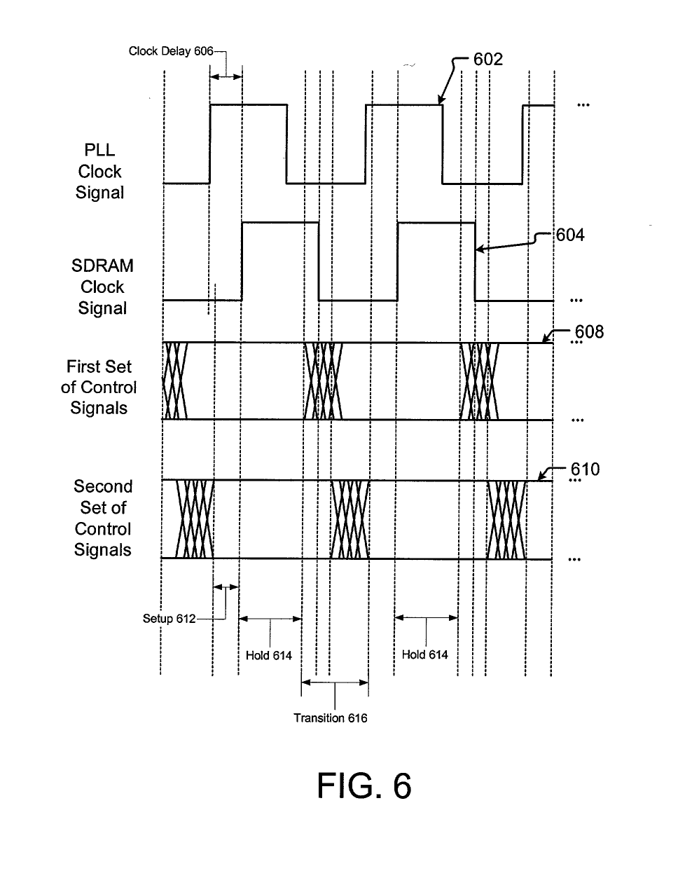

FIG. 6 illustrates an exemplary timing diagram of sample wave forms associated with the control module shown in FIG. 4 with control signals divided into two in order to illustrate the effect of staggering the output signals. As shown in FIG. 6, a PLL clock signal 600 provides a clock signal based on the system clock. Additionally, SDRAM clock signal 602 is delayed by clock delay 604. As discussed above with respect to FIG. 5, the clock signal 604 is delayed from the PLL clock signal based on the buffer characteristics 420. Also, as discussed above, the clock may be faster than the system clock. Additionally, as shown in FIG. 6, there is a first set of control signals 608 that provides data on some of the control lines 418. This first set of control signals has a predetermined delay as compared to the SDRAM clock signal 602. The delay related to the first set of control signals, as compared to SDRAM clock signal 602, is based on the delay characteristics of control or delay elements 424 and 430, as well at the latch itself 412. That is, the first set of control signals is represented by a first set of delay elements. As may be further understood, numerous latches and corresponding control signals may be involved in the first set of control signals wherein the first set of control signals is characteristically defined as having a first delay characteristic based on control elements 424 and 430.

As shown in FIG. 6, a second set of control signals is also conducted or launched by the control module 402. The second set of control signals 610 is delayed from the rising edge of the clock signal 602 by an amount determined by delay elements 424, 426 and 428. That is, the second set of control signals is represented in FIG. 4 by the path incorporating delay elements 424 and 426, latch 410, delay element 428 and output 414. Since there are more delay elements in this particular path, as compared to the first set of control signals, this second set of control signals associated with this path are delayed longer than the first set of control signals. Although the second set of control signals are delayed, the information still satisfies predetermined setup times 612 and hold times 614. That is, the information on the control lines is stable at least a predetermined period of time, e.g., the setup time 612, before the rising edge of the SDRAM clock signal 604 and held stable for at least a predetermined period of time, e.g., the hold time 614, following the rising edge of the SDRAM clock signal 614.

As can be seen by FIG. 6, there may be some overlap between control signals associated with the first set of control signals 606 and the control signals associated with the second set of control signals 610. For instance, a transition time 616 may be designed to launch the control signals wherein the various launch times may overlap to some extent. This overlap may relate to transmission line variances or other PVT variances in the system. Importantly, however, the general timing of the outputs 414 as compared with outputs 416 do not occur simultaneously due to the additional delay element 428. By making sure that the outputs 414 and 416 do not switch substantially simultaneously, the impact of SSO on the system 402 and the remaining elements of the microprocessor based system is reduced.

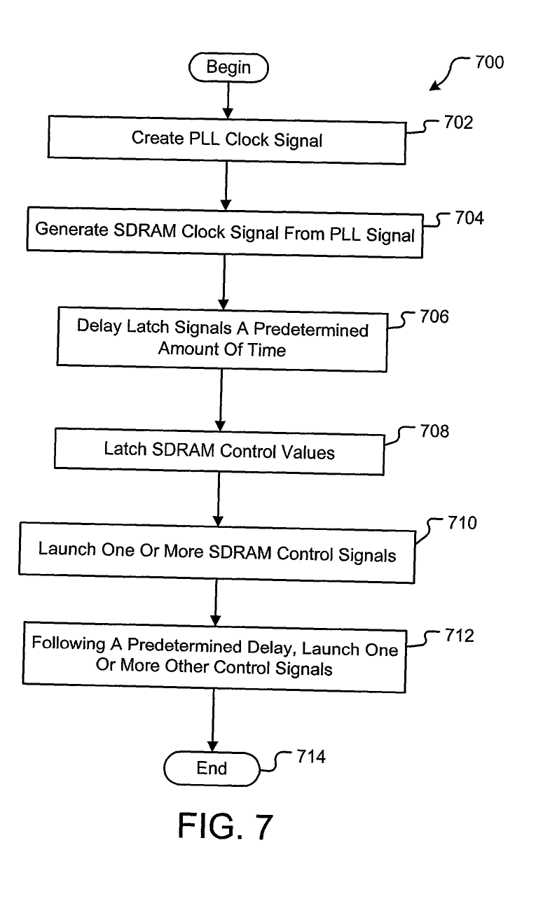

FIG. 7 illustrates the functional components of an embodiment of the present invention. The flow 700 relates to the generation of a clock signal to be provided to the SDRAM modules, such as modules 404 and 406 (FIG. 4) in such a manner as to reduce the impact of SSO as well as the impact of PVT. The setup and hold times for each SDRAM module are predetermined based on internal characteristics of the SDRAM modules. Process 700 begins as create operation 702 creates a phase lock loop (PLL) control signal. In an embodiment, the phase lock loop control signal is based on the system clock but other embodiments may base the phase lock loop control signal on another signal apart from the system clock. The created phase lock loop control signal is a repeating clock signal as is known in the art. The PLL signal is provided to a clock fanout structure to control the latch timing, i.e., the time which values are latched into the controller as well as the timing related to when control signals are launched on control lines, such as lines 418 (FIG. 4). In other words, the PLL signal is duplicated and then propagated, substantially in parallel to multiple latch components, such as latches 410 and 412 (FIG. 4). These latch signals trigger the latches in order to latch values into the controller.

Following create operation, generate operation 704 generates an SDRAM clock signal from the phase lock loop signal. The generation of the SDRAM clock signal 704, in one embodiment, involves buffering the output of the phase lock loop control signal to create an SDRAM clock signal, such as signal 422 (FIG. 4) to be provided to the SDRAM modules. In other embodiments, the generation of the SDRAM clock signal 704 may draw a signal from within the clock fanout structure, such as immediately after delay element 424 (FIG. 4) in order to ensure a proper delay between the SDRAM clock signal and the SDRAM control signals on lines 418 (FIG. 4).

Upon generation of the clock signal at 704, delay operation 706 delays one or more latch signals for a predetermined amount of time. The latch signals are delayed based on the setup and hold requirements of the SDRAM modules. The latch signals that are delayed correspond to the clock fanout structure signals that latch both address and data values into the controller. These values ultimately relate to the SDRAM control signals conducted to the SDRAM modules. In an embodiment, all latch signals are delayed the same amount of time in order to control the setup and hold times for the SDRAM module. For example, the delay operation 706 may relate to introduced delays cause by delay elements 424, 426 and 430 (shown in FIG. 4).

Next, latch operation 708 latches the SDRAM control values into the controller.

Following latch operation 708, launch operation 710 launches one or more SDRAM control signals onto control lines, such as control lines 418, (FIG. 4). Launch operation 710 may involve buffering the output of one or more latches. The SDRAM control signals relate to address and data values latched into the controller during operation 708.

Once one or more SDRAM control signals have been launched at operation 710, another launch operation 712 takes place. Launch operation 712 launches one or more other SDRAM control signals following a predetermined delay. In essence, operation 712 delays a predetermined amount of time following launch operation 710 and then launches one or more other SDRAM control signals. Launch operation 712 introduces a staggered output timing of SDRAM control signals, such as control signals 418 shown in FIG. 4. Importantly however, the second set of control signals is still launched in a manner that does not violate the setup and hold time requirements of the SDRAM modules. Once all of the signals have been launched, the operation ends at 712.

In essence, flow 700 illustrates the concept of first generating an SDRAM clock signal and then, following a predetermined delay launching a first set of SDRAM control signals. Flow 700 also illustrates the launching of a second set of control signals following another predetermined delay occurring after the first set of SDRAM control signals have been launched. Staggering the launching operations of the first and second set of SDRAM control signals reduces the impact of SSO since the many switches used to launch the SDRAM control signals generally do not operate simultaneously. As may be apparent, more than two sets of SDRAM control signals may be staggered in this manner to further reduce the impact of SSO. Importantly, the SDRAM control signals must be stable based on the setup and hold times of the SDRAM modules, and once those timing characteristics are adhered to, many variations of staggering the control signals may be employed.

The benefits of the system described above related to a control module that provides a clock signal to SDRAM modules while reducing the impact of process voltage and temperature, and the impact of SSO. As such, the present invention may be viewed as a memory controller (such as controller 402) for controlling the timing of a memory clock signal (such as signal 504), the memory clock signal being conducted to synchronous dynamic random access memory modules (such as modules 404 and 406). Typically, the memory modules are part of a system having a host computer system (such as system 202) that operates in accordance with a system clock signal (such as system clock signal 502). Within the controller (such as 402), there is a phase lock loop module (such as 408), the phase lock loop module receives the system clock signal from the host computer system. The controller also has a plurality of latches (such as latches 410 and 412), the plurality of latches receiving information from the host computer system, the information is used to control the memory modules, the latches also receiving an internal clock signal from the phase lock loop module. The controller further has a plurality of buffers (such as buffers 414 and 416), each buffer is associated with one of the plurality of latches (such as 410 and 412), wherein each latch sends a latch signal to the associated buffer, each buffer sends an information signal to at least one memory module (such as 404 and 406). Moreover, the controller has a clock buffer (such as 420) that receives a clock signal from the phase lock loop module and conducts a clock signal to one or more memory modules. The clock buffer (such as 420) is substantially similar to the buffers associated with the latches to allow for tracking across process, voltage and temperature.

Implementing delays in the clock fanout tree (such as through delay elements 424, 426, 428 and 430) has an advantage over using outputs with different delays in that the elements 424, 426, 428 and 430 in the clock fanout structure come in smaller increments of time delay, and achieving a timing delay that is substantially identical to the hold time requirement of the SDRAM module is generally easier. In addition, previous attempts to simply use faster output buffers to achieve the hold time requirement created other problems. For instance, the faster buffers have faster edge rates, lower “on resistance”, and do not have small increments of time delay. Faster edge rate buffers generally have a higher frequency content, which is undesirable for containing EMI. Low “on resistance” increases the amount of current between the voltage rail and the ground rail during switching time which causes SSO noise. In addition, generally, the timing deltas between the faster buffers and more “normal” buffers exceeds the hold requirement of the SDRAM modules, which results in a larger than necessary delay under worst-case PVT conditions. This excess delay under worst-case conditions had a direct effect on the setup time requirements for the SDRAM modules. The present invention solves this problem by using similar output buffers for both the SDRAM control signals as well as the SDRAM clock signal. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A memory controller for controlling the timing of a memory clock signal, the memory clock signal being conducted to one or more memory modules, the memory modules being part of a system having a host computer system, the controller comprising:
at least one latch element, the at least one latch element receiving information from the host computer system, the information is used to control the memory modules;
at least one output element associated with the at least one latch element, wherein the at least one latch element conducts a control signal to the associated output element, and wherein the at least one output element launches an information signal to the at least one memory module; and
a clock buffer, the clock buffer receiving a clock control signal and conducting a memory clock signal to the one or more memory modules, wherein the clock buffer is substantially similar to the at least one output element associated with the at least one latch.

2. A controller as defined in claim 1 comprising two or more latch elements and wherein each latch element is associated with one output element.

3. A controller as defined in claim 2 further comprising a plurality of delay elements, wherein the delay elements delay the timing of the latch elements.

4. A controller as defined in claim 3 wherein the delay associated with the timing of the latch elements is a predetermined time period, the predetermined time period is substantially equal to a hold time requirement of the one or more memory modules.

5. A controller as defined in claim 4 wherein the one or more memory modules are synchronous dynamic random access memory modules.

6. A controller as defined in claim 5 wherein the clock buffer and the output elements exhibit the same timing characteristics across variations in process, voltage and temperature.

7. A controller as defined in claim 4 having at least one additional delay element, the additional delay element delaying the timing of at least one output element to operate at a different time from at least one other output element.

8. A controller as defined in claim 4 wherein the operation timing of the output elements is staggered.

9. A controller as defined in claim 2 wherein the clock signal supplied to one latch is delayed in comparison to the clock signal delivered to at least one other latch.

10. A controller as defined in claim 2 wherein the one or more memory modules are synchronous dynamic random access memory modules having predetermined setup and hold timing requirements, the controller further comprising:
a phase lock loop module, the phase lock loop module receiving a system clock signal from the host computer system and producing the clock control signal, the clock control signal delivered to the clock buffer;
a clock fanout structure, the clock fanout structure receiving the clock control signal and generating latch control signals, the latch control signals delivered to the plurality of latch elements, the clock fanout structure having a plurality of delay elements, the delay elements introducing a predetermined delay between the clock signal delivered to the clock buffer and the latch control signals delivered to the latch elements; and
wherein the predetermined delay is related to the hold timing requirement of the one or more memory modules.

11. A method of controlling the timing of a memory clock signal conducted to one or more synchronous dynamic random access memory modules, the memory modules receiving control signals from a controller on control lines, the control signals being launched onto the control lines using output elements, the method comprising:
(a) creating an internal clock signal;
(b) transmitting the internal clock signal to a clock buffer, the clock buffer delaying a predetermined amount of time before switching;
(c) conducting the clock buffer switching output to the memory module as the memory clock signal; and
wherein the clock buffer is substantially similar to the output elements.

12. A method of controlling the timing of control signals as defined in claim 11 further comprising, the method comprising:
(d) delaying the plurality of control signals a predetermined amount of time before launching, the predetermined amount of time relating to a hold-time requirement of the one or more synchronous dynamic random access memory modules.

13. A method as defined in claim 12 further comprising:
(e) delaying one or more control signals a second predetermined amount of time to stagger the launching time of the output elements.

14. A method as defined in claim 11 wherein the act of creating an internal clock further comprises:
receiving a system clock signal; and
converting the system clock signal into the internal clock signal using a phase lock loop module.

15. A method as defined in claim 14 the act of launching the control signals on the control lines further comprises:
conducting the internal clock signal to a clock fanout structure to generate a plurality of latch control signals;
conducting each latch control signal to at least one latch element to latch control values into the controller; and
upon latching the control values, conducting control signals to the output elements to be launched onto the control lines.

16. A method as defined in claim 15 wherein the clock fanout structure introduces a predetermined clock fanout structure delay in the latch control signals.

17. A method as defined in claim 16 wherein the latch elements have an associated predetermined latch delay, and wherein the combination of the clock fanout structure delay and the predetermined latch delay is substantially equal to the hold-time requirement of the one or more memory modules.

18. A method as defined in claim 16 further comprising:
staggering the timing of the plurality of output elements to reduce the impact of simultaneously switching outputs.

20. A disc drive system comprising:
one or more synchronous dynamic random access memory modules for storing information; and
a controller to control the timing of the transmission of data and clock signals to the synchronous dynamic random access memory modules.

21. A disc drive system as defined in claim 20 wherein the controller comprises:
a plurality of output buffers for controlling the transmission of the data signals to the synchronous dynamic random access memory modules;
a clock buffer for controlling the transmission of the clock signal to the synchronous dynamic random access memory modules; and
wherein the clock buffer is substantially similar to the plurality of output buffers.
